(19) United States
(12) Patent Application Publication
(10) Pub. No.: US 2025/0050739 A1
(43) Pub. Date: Feb. 13, 2025

(54) SYSTEMS AND METHODS FOR TRANSIENT SUPPRESSION

(71) Applicant: Rivian IP Holdings, LLC, Irvine, CA (US)

(72) Inventors: Young Doo, La Palma, CA (US); Navin Pillai, Carson, CA (US)

(21) Appl. No.: 18/447,899

(22) Filed: Aug. 10, 2023

(51) Int. Cl. B60L 3/00; H02M 7/00

(52) U.S. Cl. CPC B60L 3/003; B60L 3/0061; H02M 7/003; B60L 2210/40

(57) ABSTRACT

Transient signal suppression is provided. A system includes a choke. The choke includes an inner surface defining a cavity, the inner surface configured to surround a plurality of conductive elements. The choke includes an outer surface configured to couple with a housing for the plurality of conductive elements.

### INTRODUCTION

Electric vehicles can include electrical propulsion systems. Such systems may convey electrical signals along various paths, and may condition the electrical signals.

### SUMMARY

This technical solution is generally directed to systems, methods and apparatuses for transient suppression. A choke can include nanocrystalline iron-based alloys or other nanocrystalline materials to form nanocrystalline magnetic cores. Such a choke can be disposed within a housing which is configured to receive conductive elements (e.g., busbars) to suppress transients which couple (wired or wirelessly) into the conductive elements. The choke can interface (e.g., couple) with the housing, either directly or indirectly via an intermediate material, such as a non-conductive potting material to mechanically stabilize the choke. The housing can include a cavity to receive the choke or the potting, such as a “raceway” shaped cavity defined by opposing sidewalls. Seal elements (e.g., O-rings or gaskets) can prevent ingress or egress of the potting material, lubricants, coolants, or other material between the cavity and the conductive elements or other housing portions.

At least one aspect is directed to a system. The system can include a choke. The choke can include an inner surface defining a cavity. The inner surface can surround a plurality of conductive elements. The choke can include an outer surface. The outer surface can couple with a housing for the plurality of conductive elements.

At least one aspect is directed to a device. The device can be or include a housing. A first sidewall of the housing can include an outer surface thereof. A second sidewall of the housing can include an inner surface thereof. The inner surface of the second sidewall can face the outer surface of the first sidewall to define a cavity. The cavity can be configured to receive a choke. The choke received in the cavity can surround a plurality of conductive elements bounded by the first sidewall.

At least one aspect is directed to a system. The system can include a housing. The housing can include a first sidewall including an outer surface thereof. The housing can include a second sidewall including an inner surface thereof, the inner surface of the second sidewall facing the outer surface of the first sidewall to define a cavity. The system can include a choke. The choke can include an inner surface configured to surround a plurality of conductive elements. The choke can include an outer surface configured to couple with the housing.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example exploded diagram of a transient suppression system.

FIG. 2 depicts another example exploded diagram of a transient suppression system.

FIG. 3 depicts an example electric vehicle.

FIG. 4 depicts an example cutaway view of an inverter-motor assembly.

FIG. 5 depicts an example cross-sectional view of an inverter-motor assembly.

FIG. 6 depicts an example top view of the transient suppression system of FIG. 1.

FIG. 7 depicts an example lengthwise profile view of the transient suppression system of FIG. 1.

FIG. 8 depicts an example widthwise profile view of the transient suppression system of FIG. 1.

FIG. 9 depicts a flow diagram for an example method of fabricating a transient suppression system.

### DETAILED DESCRIPTION

Following below are more detailed descriptions of various concepts related to, and implementations of, methods, apparatuses, and systems of transient suppression devices. The various concepts introduced above and discussed in greater detail below may be implemented in any of numerous ways.

This disclosure is generally directed to a choke integrated into a housing including bus bars for various phases (e.g., three phases) for an AC motor, such as for an interconnect between the AC motor and an inverter. The choke can be received into a “raceway” of the housing between an inner and outer sidewall, and interface with a potting material to mechanically secure the (e.g., common mode) choke, along with the bus bars. The choke can laterally surround the bus bars. The housing can interface with an endcap such that the housing can envelope the choke. The choke can filter transients or ripple induced from inverter switching, environmental conditions, or vehicle operation.

Such filtering can reduce resistive losses and arcing which can impact efficiency or wear of equipment (e.g., vehicle) components. Thus, a choke, such as a common mode choke can reduce transient currents which can prevent arcing or other transient current levels which can lead to, for example, bore bearing pitting or heating of oil in a sealed unit motor. The choke of the present disclosure can integrate into various spaces which may not receive other chokes, and further benefit from mechanical or ingress protection of a housing for busbars. Such mechanical ingress or protection can reduce exposure to chemical or mechanical stressors from various lubricants, coolants, or environmental conditions present or interfacing with equipment including an electric vehicle.

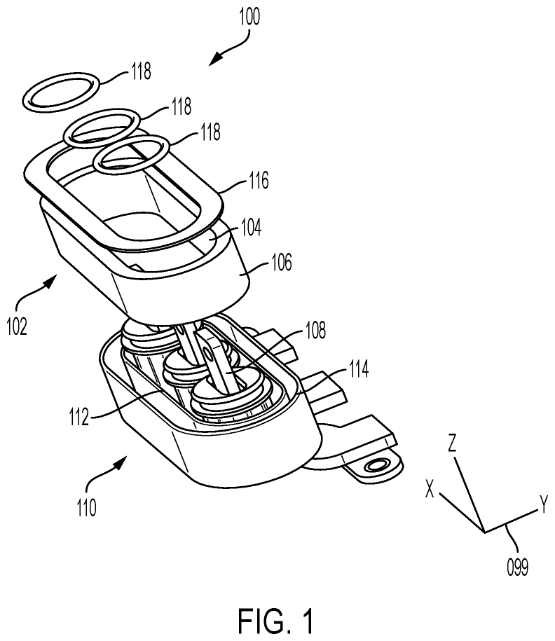

FIG. 1 depicts an example exploded diagram of a transient suppression system 100. The exploded diagram of the system 100 is depicted along an axis 099 extending in a ‘Z’ direction, which may be referred to as a “top” or “upper” surface, side, or direction. References to “top,” “upper,” or the like may refer to the depiction provided in FIG. 1, and are not intended to limit an orientation of the transient suppression system 100 (e.g., during fabrication processes, or as installed in an electric vehicle). An ‘X’ direction, perpendicular to the ‘Z’ direction, may be referred to as a “longitudinal” or “lengthwise” direction. A ‘Y’ direction, perpendicular to the ‘Z’ direction and the ‘X’ direction, may be referred to as a “transverse” or “widthwise” direction.” Plane extending in the ‘X’ and ‘Y’ direction may be referred to as lateral planes. The axis 099 is provided for clarity of references to the various transient suppression systems 100 depicted herein, and is not intended to have a limiting effect on the present disclosure.

The transient suppression system 100 can include a choke 102 including magnetic material. The choke 102 can form a loop (e.g., annular shape along a lateral plane). Such a choke 102 can include the depicted elliptical curvilinear shape, or other shapes such as toroidal, u-shaped, drum-shaped, e-shaped, or square or rectangular shaped. The choke 102 may be closed along one or more lateral planes. An inner surface 104 of the choke 102 can define a cavity in one or more lateral planes. The cavity can be configured to receive any number of conductive elements 108 (e.g., cables or busbars), such that the system 100 can include or interface therewith. That is, the choke 102 can laterally envelop the conductive elements 108. For example, the cavity can receive three alternating current (AC) busbars corresponding to three phases of an AC motor for an electric vehicle. That is, conductive elements 108 laterally enveloped by the choke 102 can electrically connect a multi-phase (e.g., three phase) motor to an inverter.

The choke 102 can include a magnetic material. For example, the choke can include one or more nanocrystalline materials forming nanocrystalline magnetic cores. The nanocrystalline materials can be formed along a metalized tape. The nanocrystalline materials can include various iron-based (e.g., iron including) alloys, which may include, without limitation, metallic glasses such as iron-boron alloys, iron-silicon alloys, or iron phosphorous alloys. Some of the iron-based alloys can include cobalt or nickel, such as Permalloy or Mu-metal. Further metals or other materials, such as zinc or zinc-iron alloys, can provide a barrier to various environmental or vehicle materials, such as the potting materials or environmental contaminants.

The transient suppression system 100 can include a housing 110. The housing 110 can include a first, inner sidewall 112 and a second, outer sidewall 114 defining a cavity to receive the choke 102. Where useful for clarity, the cavity may be referred to as “raceway” cavity to distinguish from any other cavities of the housing 110. Such a reference is not intended to be limiting; the cavity can include various geometries. For example, another cavity may refer to a portion of the raceway laterally enveloped by the choke along at least one lateral plane. That is, the raceway cavity can include a first portion bounded by the choke 102 and the inner sidewall 112, and a second portion bounded by the outer sidewall 114 and the choke.

The cavity can receive a potting material (not depicted) or other material to mechanically support the choke 102. The housing 110 can include an opening to receive one or more conductive elements 108. For example, the conductive elements 108 may be received substantially perpendicular to a lateral plane passing through the choke 102. As depicted, an inner sidewall 112 can bound the cavity from the portion of the housing 110 configured to receive the conductive elements 108, which can include mechanical support therefor. The cavity (e.g., raceway) can extend, perpendicular to a lateral plane (e.g., along the ‘Z’ axis) for a distance less than the z-dimension of the choke 102, such that the choke 102 can be received into the cavity. The inner surface of the choke 102 can surround an inner sidewall 112 of the housing, along with any conductive elements or seals (e.g., O-rings 118) along a lateral plane. A lateral plane in which the choke 102 surrounds the conductive elements 108 may be referred to as a bounding plane for the conductive elements.

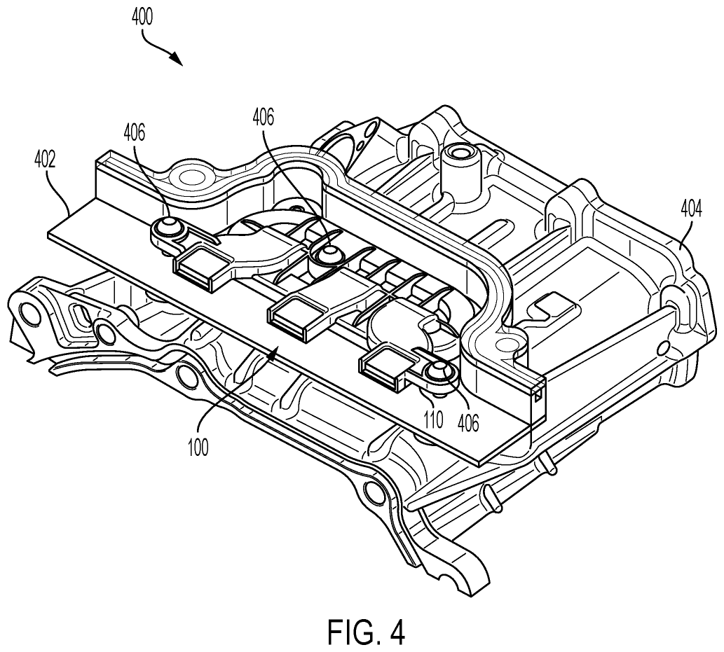

The housing 110 can include or be configured to interface with a cap 116 to bound or define an upper portion of the cavity. The cap 116 can enclose the cavity so as to prevent an egress of the potting material from the cavity, or an ingress of lubricants, coolants, or environmental contaminants into the cavity. For example, the conductive elements 108 can extend (upwards, as depicted) beyond the cap 116 to extend, when installed into a vehicle, into another housing such as a motor housing (as is depicted in FIG. 4). The other housing can include a coolant such as an oil-based coolant. The housing 110 can further be configured to interface with a seal element such as the depicted O-rings 118, which can be configured to interface with (e.g., seal) a material of the other housing such as the oil-based coolant thereof from the cavity or other portions of the housing 110. For example, the O-rings 118 can seal motor coolants, oils, or other materials from a motor housing from entering a cavity or otherwise interfacing with the choke 102. The O-rings 118 can be constructed of or include fluroelastomers such as Fluorine Kautschuk Materials (FKM). Such materials may be configured to interface with oils which the O-ring 118 can contact, such as oils in an ambient environment (e.g., electric motor oil) or lubricants of the O-ring 118. Such lubricants can include dry lubricants such as McLube 419.

The housing 110 can be formed (e.g., injection molded, thermoformed, or compression molded) from materials configured to interface with the potting material, the materials can include metals or thermoplastics such as polyamide-imide, polyphenylene sulfide (PPS), Polyetheretherketone, or Polyimides (e.g., glass fiber reinforced PPS such as PPS 40). Such materials can be selected for temperature, chemical, or flame resistance; electrical insulation; or moisture absorption rejection. The housing 110 can be formed from one or more structures, such as an insert to interface with an inner surface of the inner sidewall 112 of the housing to receive the conductive elements or O-rings 118.

The outer surface 106 of the choke 102 can interface with the outer sidewall 114 of the housing 110. That is, the outer surface 106 of the choke 102 can face and abut, directly or indirectly, with the outer sidewall 114. Some portions of the choke 102 can directly abut the outer sidewall, and other portions can be intermediated by the potting material (e.g., according to a choke deformation or disposition). The inner surface of the inner sidewall 112 of the housing 110 can surround the various conductive elements 108 or sealing elements, or can prevent egress of the potting material from the raceway cavity to interfere with the conductive elements 108.

The choke 102 can interface with the potting material, such as directly interfacing therewith. A film such as a zinc including film or other metallization or coating of the choke 102 can directly contact the potting material. The potting material can be insulative, provide mechanical support, or reduce environmental stresses borne by the choke 102, such as moisture, dust, heat, shock, or vibration associated with an electric vehicle. The potting material can be or include an epoxy resin, silicone resin, or polyurethane resin. For example, an epoxy resin may be selected for mechanical strength or chemical resistance; a silicone resin (e.g., TSE3854DS W) may be selected for thermal stability or flexibility; or a polyurethane resin can be selected for flexibility or electrical properties (e.g., dielectric properties). Such illustrative examples are not intended to be limiting, and the present disclosure contemplates various additional potting materials, combinations thereof, or the like.

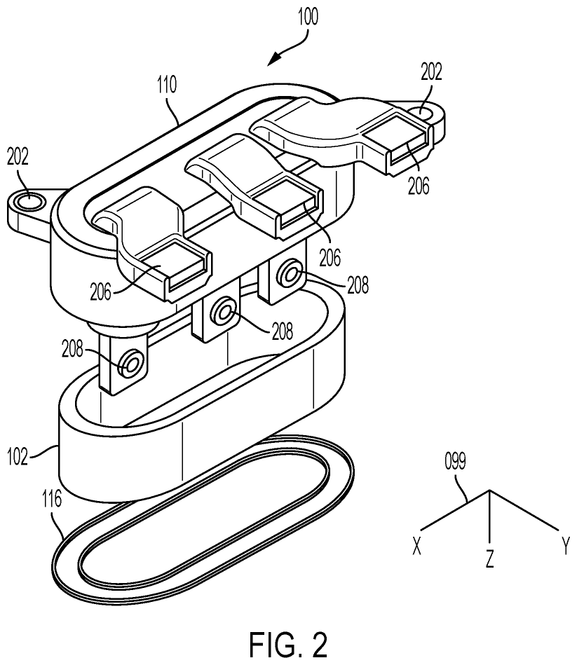

FIG. 2 depicts an example exploded diagram of a transient suppression system 100. For example, the depicted transient suppression system 100 can be in inverted view of the transient suppression system 100 of FIG. 1, or a variant thereof. The housing 110 can include mounting points 202, such as integral or connected mounting points 202. The mounting points 202 can be configured to receive a fastener such as a screw, rivet, pin, or clip. The cap 116 can cover or retain the choke 102 in the raceway cavity of the housing 110, such that the connection of the mounting points 202 to another surface (e.g., a motor housing) can compress or secure the depicted exploded stack up.

As depicted, The conductive elements 108 can terminate at a clinch nut 208 or other terminal connector which can be configured to couple the conductive elements 108 to a corresponding electrical connector, such as a bus bar or cable of an electric motor. An opposite end 206 of the conductive element 108 can extend from the housing 110 to electrically connect to another electrical connector, such as to an inverter, via a terminal lug or other terminal connector. As assembled, the transient suppression system 100 can thus include a housing which is sealed, such as hermetically sealed, dust sealed, fluidically sealed, or otherwise configured to prevent an ingress of various contaminants. The seal can extend along one or more protrusions of the conductive elements 108 from the housing 110. For example, the seal can extend along the end of the conductive elements 108 depicted with the connected clinch nuts 208, or the opposite end 206 of the conductive elements 108. The conductive elements 108 can extend from the housing 110 along different planes. For example, the end of the conductive elements 108 depicted with the connected clinch nuts 208 can extend perpendicular to the lateral plane. The opposite end 206 of the conductive elements 108 can extend along with lateral plane.

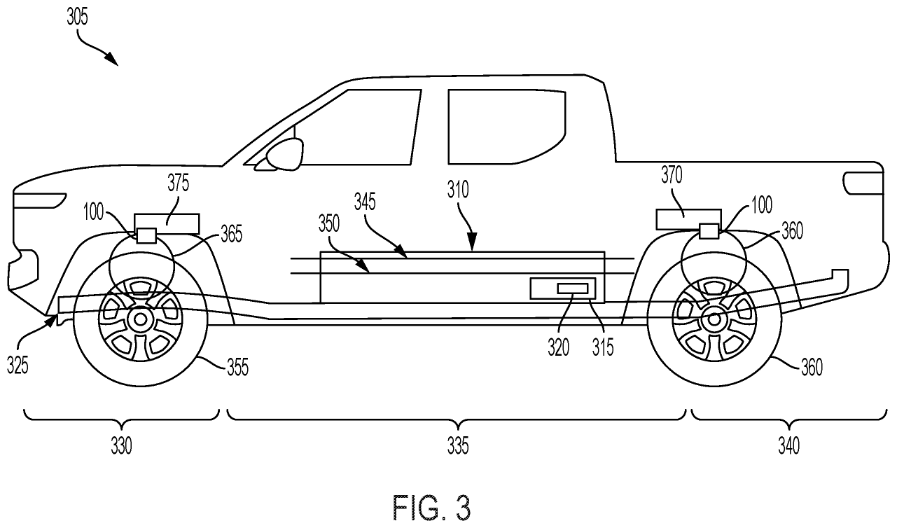

FIG. 3 depicts an example cross-sectional view of an electric vehicle 305 installed with at least one battery pack 310. Electric vehicles 305 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 310 can also be used as an energy storage system to power a building, such as a residential home or commercial building. Electric vehicles 305 can be fully electric or partially electric (e.g., plug-in hybrid) and further, electric vehicles 305 can be fully autonomous, partially autonomous, or unmanned. Electric vehicles 305 can also be human operated or non-autonomous. Electric vehicles 305 such as electric trucks or automobiles can include on-board battery packs 310, batteries or battery modules 315, or battery cells 320 to power the electric vehicles. The electric vehicle 305 can include a chassis 325 (e.g., a frame, internal frame, or support structure). The chassis 325 can support various components of the electric vehicle 305. The chassis 325 can span a front portion 330 (e.g., a hood or bonnet portion), a body portion 335, and a rear portion 340 (e.g., a trunk, payload, or boot portion) of the electric vehicle 305. The battery pack 310 can be installed or placed within the electric vehicle 305. For example, the battery pack 310 can be installed on the chassis 325 of the electric vehicle 305 within one or more of the front portion 330, the body portion 335, or the rear portion 340.

The battery pack 310 can include or connect with at least one busbar, e.g., a current collector element. For example, the first busbar 345 and the second busbar 350 can include electrically conductive material to connect or otherwise electrically couple the battery, the battery modules 315, or the battery cells 320 with other electrical components of the electric vehicle 305 to provide electrical power to various systems or components of the electric vehicle 305. For example, the battery pack 310 can connect to various inverters and electric motors (e.g., via the inverter).

Each of a front wheel set 355 and a rear wheel set 360 can interface with an inverter-motor pair. For example, a front wheel set can interface with a single inverter-motor pair connected to the front wheels via a differential, or can include a separate motor-inverter pair for each driven wheel. Thus, the front wheel set 355 can interface with at least one front motor 365 coupled to a front inverter 375 via a front transient suppression system 100. The rear wheel set 360 can interface with at least one rear motor 370 coupled to a rear inverter 380 via a rear transient suppression system 100. In some vehicles the front and rear inverter-motor pairs may be a same inverter-motor pair connected via a differential, or the a front or rear inverter-motor pair may be omitted (e.g., in front or rear wheel drive vehicles).

Referring now to FIG. 4, an example cutaway view 400 of an inverter-motor assembly is provided. The cutaway view 400 includes an inverter housing 402 proximal to a motor housing 404. The inverter housing 402 can couple to the motor housing 404 via bolts, or other fasteners. A coupling between the inverter housing 402 and the motor housing 404 can form a seal therebetween.

The housing 110 for the transient suppression system 100 is shown disposed within the inverter housing 402, wherein one end of the various conductive elements 108 can extend into the motor housing 404. Various fasteners 406 can pass through the housing 110 for the transient suppression system 100, and may be received by the inverter housing 402 (e.g., threads thereof). The fasteners 406 can apply pressure to the housing 110 which may form a seal due to a clamping force between the housing 110 for the transient suppression system 100 and the inverter housing 402. For example, as depicted, a fastener 406 can intermediate the conductive elements 108 from each other. In some instances, the fastener 406 intermediating the conductive elements 108 can be omitted. The conductive elements 108 can be spaced equidistant from each other. For example, three conductive elements 108 can be disposed substantially equal from each other in a triangular geometry, or substantially equal from adjoining conductive elements 108 of a linear (e.g., in-line) geometry.

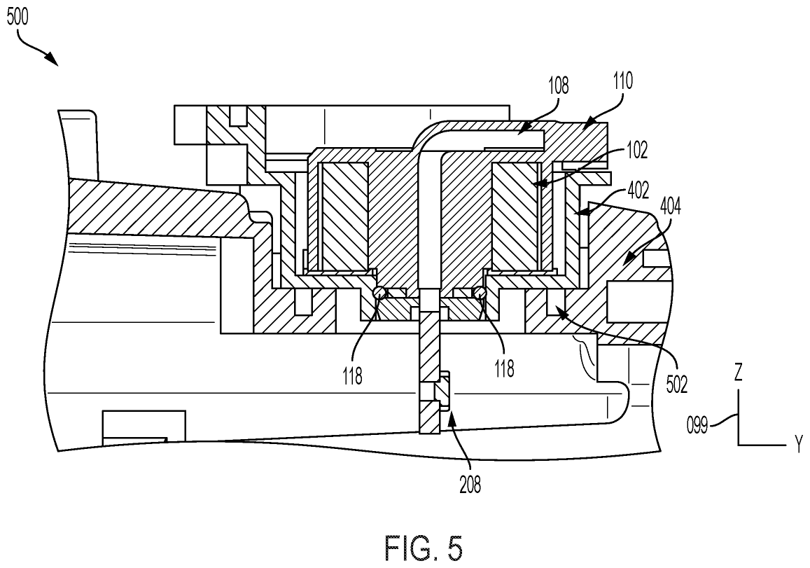

Referring now to FIG. 5, an example cross-sectional view 500 of an inverter-motor assembly is provided. A cut line of the cross-sectional view 500 extends through each of the housing 110 for the transient suppression system 100, choke 102, conductive element 108, inverter housing 402, motor housing 404, and O-ring 118.

The conductive elements 108 can extend into an inverter assembly disposed within the inverter housing 402 to electrically connect to one or more phases of the multi-phase inverter assembly. An end of the conductive element 108 including the clinch nut 208 can extend into the motor assembly, which can be sealed from the raceway cavity by a seal such as an O-ring 118. Another seal such as a lip-seal 502 can connect corresponding surfaces of the inverter housing 402 and the motor housing 404.

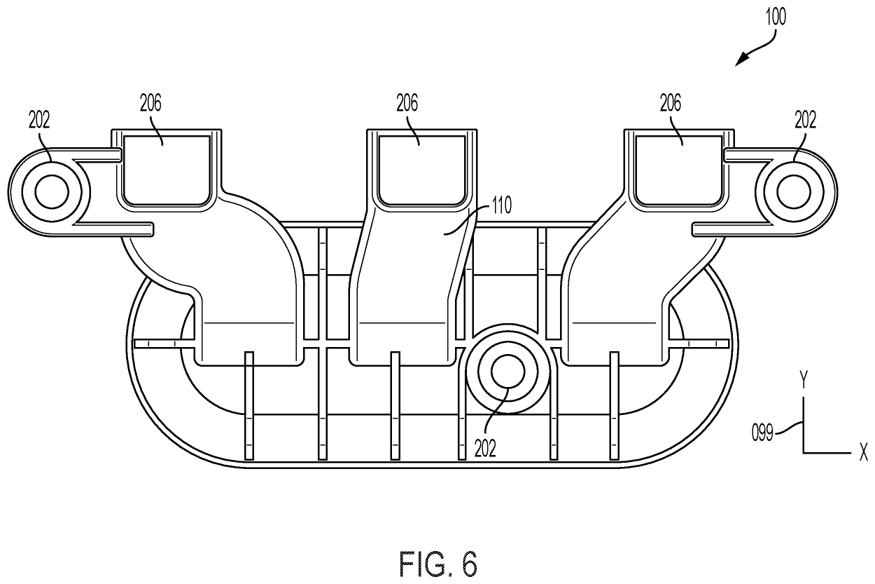

Referring now to FIG. 6, an example top view of a transient suppression system 100 is provided. For example, the depicted transient suppression system 100 can be a top view of the transient suppression system 100 of FIG. 1, or a variant thereof. The housing 110 of the transient suppression system 100 can include extensions along the lateral plane of the depicted X-Y axis 099. The extensions can envelope the conductive elements 108 from one or more directions or planes. One or more mounting points 202 can be integral or coupled to any of the housing extensions, or another portion of the housing 110. One or more mounting points 202 can be disposed laterally withing the inner sidewall 112 of the housing 110. The various mounting points 202 can include or interface with a spring element, gasket or other seal, or other elements configured to cause the connection of the housing 110 of the transient suppression system 100 to another portion of a system such as an electric vehicle 305.

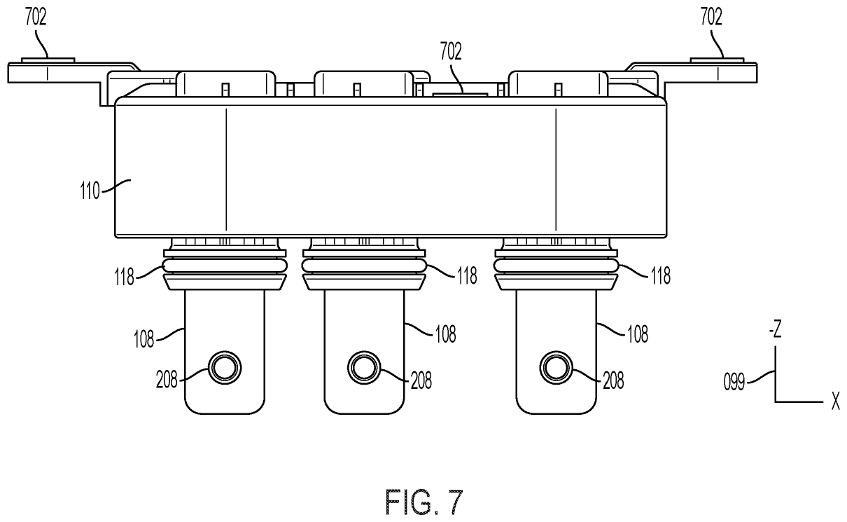

Referring now to FIG. 7, an example lengthwise profile view profile view of a transient suppression system 100 is provided. For example, the depicted transient suppression system 100 can be a side view of the transient suppression system 100 of FIG. 1, or a variant thereof. As shown, the O-rings 118 can separate a main body of the housing 110 from another portion of the system 100. The O-rings 118 can be vertically spaced from the cavity, along the Z axis 099. The other portion can include conductive elements 108 extending in a negative Z direction, towards a motor housing 404 (e.g., the portion of the conductive elements 108 previously described as to include the clinch nuts 208). Spring elements 702 can extend along the various mounting points 202 to retain the fasteners 406 therein.

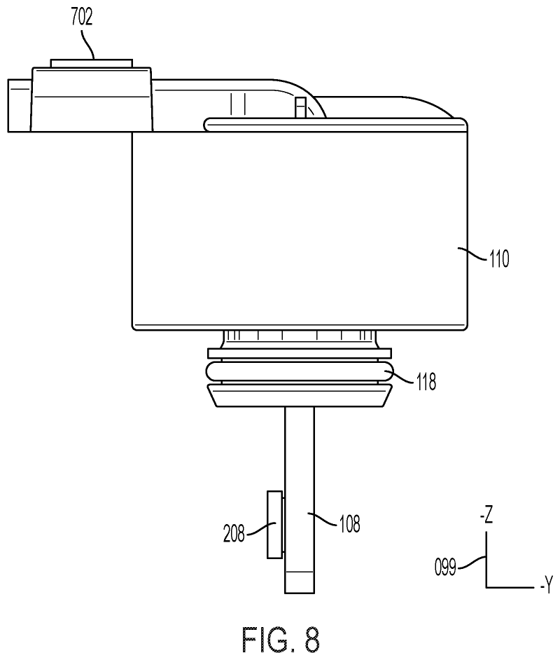

Referring now to FIG. 8, an example widthwise profile view profile view of a transient suppression system 100 is provided. For example, the depicted transient suppression system 100 can be a side view of the transient suppression system 100 of FIG. 1, or a variant thereof. Depicted in FIG. 8, are a spring element 702, and O-ring 118 coupled to the housing 110 receiving conductive elements 108. Clinch nuts 208 are shown connected to the conductive elements 108 which can connect the various phases of a multi-phase inverter assembly to the various phases of a multi-phase electric motor.

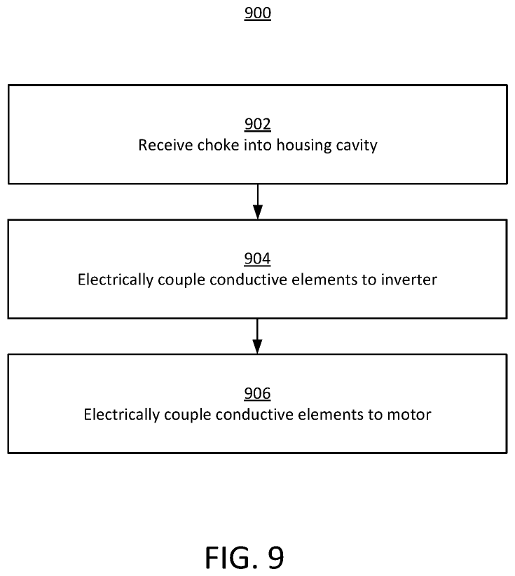

Referring now to FIG. 9, a flow diagram for an example method 900 of fabricating a transient suppression system 100 is provided. The operations of the method 900 can fabricate (e.g., assemble, manufacture, or otherwise form) or more systems or components depicted in FIGS. 1-8, or variants thereof. At ACT 902, a housing 110 receives a choke 102 into a cavity, the cavity configured to receive the choke 102. For example, the cavity can be defined by an inner sidewall 112 and outer sidewall 114 of the housing 110. The choke 102 can include an inner surface to interface with the inner sidewall 112. For example, the choke 102 can mechanically couple to the inner sidewall 112 via a material injected, poured, or otherwise introduced into the cavity to mechanically support or retain the choke 102. A cap 116 can cover a top surface of the cavity to seal the housing 110. The cap 116 can retain the potting material in the cavity. The choke 102 can envelope conductive elements 108 disposed within the inner sidewall 112 of the housing 110, such that the inner sidewall 112 bounds the choke 102 or potting material from the conductive elements 108.

At ACT 904, a first terminal end of the conductive elements 108 are connected to a multi-phase inverter. For example, the conductive elements 108 can extend from the housing 110 to a terminal connector such as a terminal lug which can connect to the inverter. For example, the terminal lug for each of the conductive elements can electrically connect to the inverter to receive a phase of a multiphase electrical signal (e.g., a three-phase signal). A housing 402 for the inverter can include, envelop, interface with, or otherwise couple to the housing 110 for the transient suppression system 100.

At ACT 906, a second terminal of the conductive elements 108 are connected to a multi-phase electric motor. For example the connection can be an electrical connection such that energy can flow from the inverter to the motor to propel an electric vehicle 305 or from the motor to the inverter (e.g., to recapture energy from regenerative braking). The connection can include passing the conductive elements into a housing 404 for the motor assembly. An interface between the housing 404 for the motor assembly and the conductive elements 108 can include one or more seal elements such as the O-rings 118 depicted herein. A body of the housing 110 for the transient suppression system 100 can abut another seal element (e.g., a lip-seal 502), such that a compressive (e.g., clamping) force applied between the respective housings 110, 404 can maintain a seal therebetween. The compressive force may be applied by one or more fasteners 406 passing through various mounting points 202 of the transient suppression system housing 110.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system, comprising:
a choke, comprising:
an inner surface defining a cavity, the inner surface configured to surround a plurality of conductive elements; and
an outer surface configured to couple with a housing for the plurality of conductive elements.

2. The system of claim 1, wherein the system comprises the plurality of conductive elements to electrically connect a multi-phase motor to an inverter.

3. The system of claim 1, wherein the choke comprises the outer surface of the choke to couple with a first sidewall of the housing.

4. The system of claim 1, wherein the choke comprises a magnetic material comprising nanocrystalline materials.

5. The system of claim 1, wherein the choke comprises the inner surface to surround a second sidewall of the housing and a plurality of seals, the second sidewall and the plurality of seals configured to separate the plurality of conductive elements from a potting material.

6. The system of claim 1, wherein the choke comprises:
a magnetic material extending a first distance, in a first direction perpendicular to a lateral plane, wherein the lateral plane is a bounding plane for the plurality of conductive elements surrounded by the inner surface of the choke; and
the housing extends a second distance, greater than the first distance, to a portion thereof configured to interface with a cap configured to retain a potting material within the housing.

7. The system of claim 1, wherein the choke is configured to couple with the housing via a potting material.

8. The system of claim 1, wherein the choke comprises:
a magnetic material extending in a first direction perpendicular to a lateral plane; and
the lateral plane is a bounding plane for the plurality of conductive elements surrounded by the inner surface of the choke.

9. A housing, comprising:
a first sidewall including an outer surface thereof;
a second sidewall including an inner surface thereof, the inner surface of the second sidewall facing the outer surface of the first sidewall to define a cavity configured to receive a choke, the choke to surround a plurality of conductive elements bounded by the first sidewall.

10. The housing of claim 9, wherein the plurality of conductive elements are to electrically connect a multi-phase motor to a multi-phase inverter.

11. The housing of claim 9, wherein the choke comprises a magnetic material comprising nanocrystalline materials.

12. The housing of claim 9, wherein the first sidewall laterally surrounds a plurality of seals vertically spaced from the cavity, the second sidewall and the plurality of seals configured to separate the plurality of conductive elements from a potting material.

13. The housing of claim 9, wherein the choke extends a first distance, in a first direction perpendicular to a lateral plane, wherein the lateral plane is a bounding plane for the plurality of conductive elements surrounded by the inner surface of the choke;
the cavity extends second distance, greater than the first distance, to a portion thereof configured to interface with a cap configured to retain a potting material within the housing; and
the housing extends a third distance, greater than the second distance to a seal element.

14. The housing of claim 9, wherein the housing is configured to couple with the choke via a potting material.

15. A system, comprising:
a housing, comprising:
a first sidewall including an outer surface thereof;
a second sidewall including an inner surface thereof, the inner surface of the second sidewall facing the outer surface of the first sidewall to define a cavity; and
a choke, comprising:
an inner surface configured to surround a plurality of conductive elements; and
an outer surface configured to couple with the housing.

16. The system of claim 15, further comprising:
a multi-phase motor electrically connected to a first end of the plurality of conductive elements; and
a multi-phase inverter electrically connected to a second end of the plurality of conductive elements opposite the first end.

17. The system of claim 15, wherein the outer surface of the choke couples with the first sidewall of the housing.

18. The system of claim 15, wherein the choke comprises a magnetic material comprising nanocrystalline materials.

19. The system of claim 15, wherein the choke comprises:
a magnetic material extending a first distance, in a first direction perpendicular to a lateral plane, wherein the lateral plane is a bounding plane for the plurality of conductive elements surrounded by the inner surface of the choke; and
the housing extends a second distance, greater than the first distance, to a portion thereof configured to interface with a cap configured to retain a potting material within the housing.

20. The system of claim 15, wherein the cavity comprises a potting material.
